(19) United States
(12) Patent Application Publication
(10) Pub. No.: US 2023/0299441 A1
(43) Pub. Date: Sep. 21, 2023

(54) COVER MEMBER

(71) Applicant: YAZAKI CORPORATION, Tokyo (JP)

(72) Inventors: Naomichi Suzuki, Makinohara-shi (JP); Hideaki Ishida, Makinohara-shi (JP)

(21) Appl. No.: 18/173,009

(22) Filed: Feb. 22, 2023

(30) Foreign Application Priority Data
Mar. 16, 2022 (JP) 2022-041708

(51) Int. Cl. H01M 50/591

(52) U.S. Cl. CPC H01M 50/591

(57) ABSTRACT

A battery terminal cover includes a base portion that is fixed to a battery and accommodates a battery terminal; a first cover that is coupled to the base portion via a first hinge and is configured to be rotationally displaceable between a shielding position at which the first cover covers a fastening bolt attached to the battery terminal and an exposed position at which the fastening bolt is exposed; and a first protruding rib that is provided in the base portion and restricts rotation of a spanner rotated about the fastening bolt by interfering with the spanner before the spanner comes into contact with a peripheral member disposed around the battery.

### CROSS-REFERENCE TO RELATED APPLICATIONS

This application is based on and claims priority under 35 USC 119 from Japanese Patent Application No. 2022-041708 filed on Mar. 16, 2022, the contents of which are incorporated herein by reference.

### TECHNICAL FIELD

The present invention relates to a cover member.

### BACKGROUND ART

In related art, as a cover member for protecting a terminal protruding from a battery, for example, a battery terminal cover disclosed in Patent Literature 1 is known. The battery terminal cover includes a body portion for accommodating a battery terminal, and a lid portion (cover) coupled to the body portion via a hinge. A fastening piece of the battery terminal covered by the battery terminal cover is fastened, by a screwing member, to an outer periphery of a battery post protruding from an upper face of a battery.

At the time of work such as battery replacement, the lid portion is rotated around the hinge to open an accommodation space of the body portion, and the screwing member (bolt) is loosened using a tool to attach and detach the battery terminal. However, when the screwing member is rotated, the rotated tool may come into contact with a vehicle body and thereby damage the vehicle body.

Therefore, a battery terminal cover (cover member) disclosed in Patent Literature 2 has been proposed. The battery terminal cover includes a body portion fixed to a battery, a movable portion (cover) coupled to the body portion via a hinge and covering a screwing member attached to the battery, and a tool restriction portion provided on the movable portion. The tool restriction portion restricts rotation of a tool by interference before the tool rotated about the screwing member comes into contact with a vehicle in a state where the movable portion is in an open position. Accordingly, it is possible to prevent the tool from coming into contact with the vehicle and damaging the vehicle.

### CITATION LIST

### Patent Literature

Patent Literature 1: JP2017-91650A

Patent Literature 2: JP2019-114392A

### SUMMARY OF INVENTION

However, in the battery terminal cover disclosed in Patent Literature 2, the tool restriction portion is provided in the movable portion coupled to the body portion via the hinge. Therefore, when the screwing member is rotated by rotating the tool, there is a possibility that a force due to an action of separating the body portion and the movable portion from each other is applied to the hinge due to the interference (contact) of the tool with the tool restriction portion. As a result, there is a concern that the hinge may be damaged due to a degree of a force applied or a force repeatedly applied.

The present invention has been made in view of the above circumstances, and an object of the present invention is to provide a cover member capable of restricting rotation of a tool and preventing damage to a hinge.

In order to achieve the above object, a cover member according to the present invention is characterized as follows.

The cover member includes a base portion that is fixed to a battery and accommodates a battery terminal; a first cover that is coupled to the base portion via a first hinge and is configured to be rotationally displaceable between a first shielding position at which the first cover covers a screwing member attached to the battery terminal and a first exposed position at which the screwing member is exposed; and a tool restriction portion that is provided in the base portion and restricts rotation of a tool rotated about the screwing member by interfering with the tool before the tool comes into contact with a peripheral member disposed around the battery.

According to the cover member of the present invention, rotation of the tool can be restricted, and damage to the hinge can be prevented.

The present invention is briefly described above. Further, the details of the present invention will be further clarified by reading through modes (hereinafter referred to as “embodiments”) for carrying out the invention to be described below with reference to the accompanying drawings.

### BRIEF DESCRIPTION OF DRAWINGS

Exemplary embodiments of the present invention will be described in detail based on the following figures, wherein:

FIG. 1 is a perspective view showing a cover member according to a first embodiment of the present invention assembled to a battery;

FIG. 2 is a perspective view showing a state in which a first cover and a second cover of the cover member shown in FIG. 1 are opened;

FIG. 3 is an exploded perspective view showing a battery terminal and a fuse unit accommodated in the cover member;

FIG. 4 is an exploded perspective view of the battery terminal;

FIG. 5 is a perspective view of the cover member as viewed from above;

FIG. 6 is a perspective view of the cover member as viewed from below;

FIG. 7 is a perspective view showing the cover member in a state before the cover member is assembled to the battery;

FIG. 8 is a perspective view showing a state in which the battery terminal is attached to the battery mounted on a vehicle;

FIG. 9 is a top view showing the state in which the battery terminal is attached to the battery mounted on the vehicle;

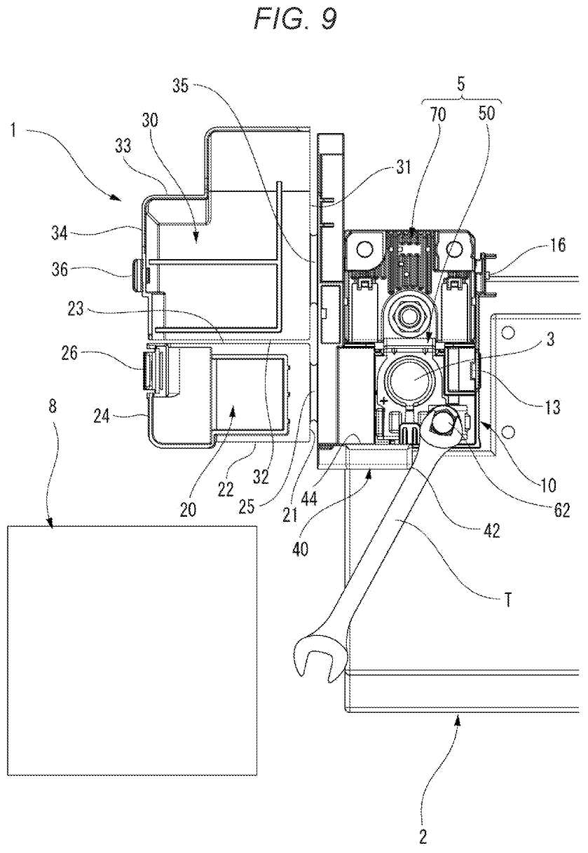

FIG. 10 is a perspective view showing an operation when the first cover of the cover member assembled to the battery is opened and closed;

FIG. 11 is a perspective view showing a state in which a first cover of a cover member according to a second embodiment of the present disclosure assembled to a battery is in an exposed position; and

FIG. 12 is a perspective view showing an operation when the first cover of the cover member shown in FIG. 11 is opened and closed.

### DESCRIPTION OF EMBODIMENTS

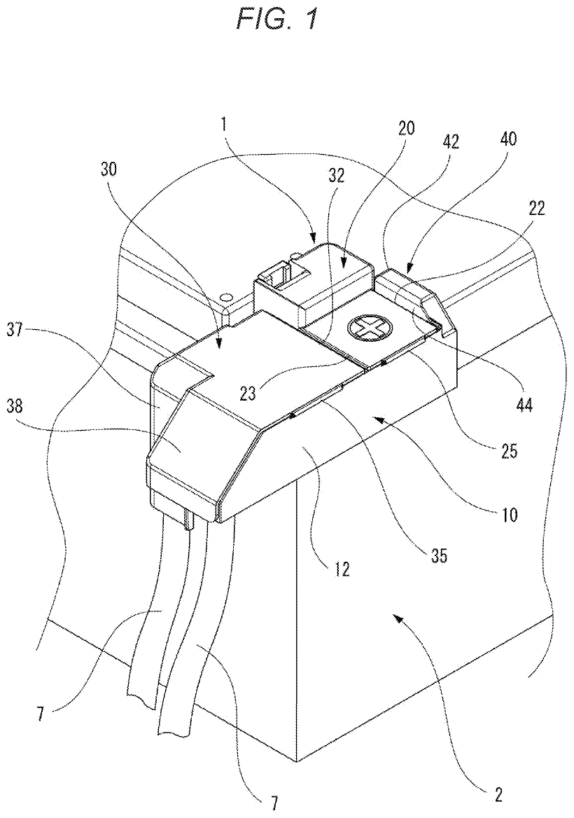

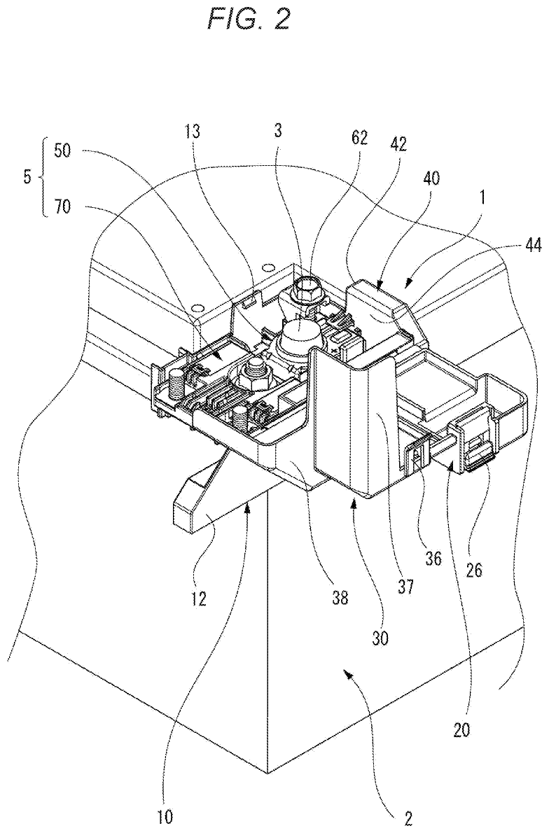

Specific embodiments of the present invention will be described below with reference to the drawings. As shown in FIGS. 1 and 2, a battery terminal cover 1 as a cover member according to a first embodiment of the present invention is mounted on an upper face side of a battery 2, and covers and protects a battery post 3 and a power connection system 5. In the present description, an upper side of the battery terminal cover 1 in the state shown in FIG. 1 will be described as an upper side.

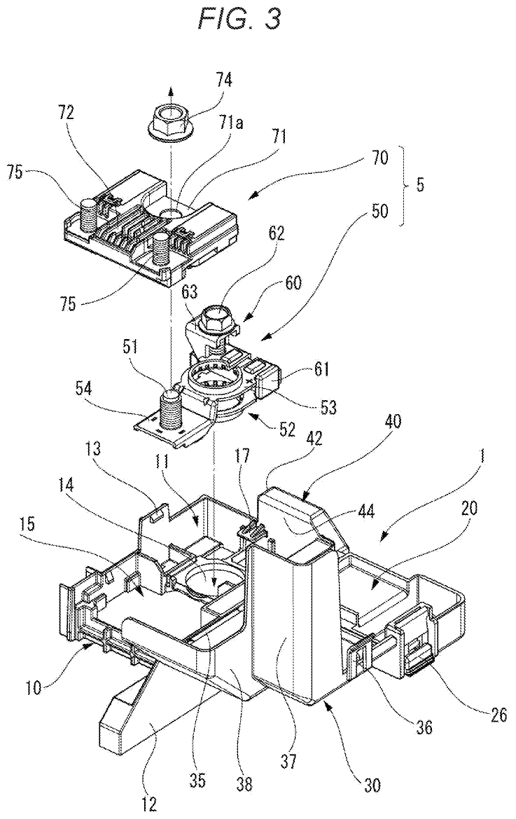

As shown in FIG. 3, the power connection system 5 of the present embodiment includes a battery terminal 50 and a fuse unit 70. As shown in FIG. 2, the power connection system 5 is assembled to the battery 2 to be interposed between the battery post 3 on a positive electrode side and electric wires 7, and electrically connects the battery terminal 50 and a fuse circuit body 71 of the fuse unit 70 to the battery post 3 and the electric wires 7. The battery post 3 is erected on the upper face of the battery 2, and the battery terminal 50 is physically and electrically connected to the battery post 3 as described later.

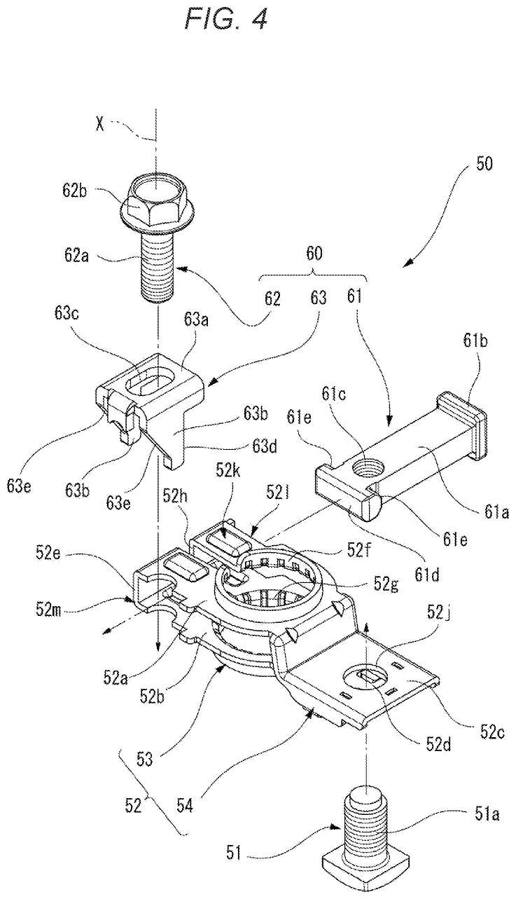

As shown in FIG. 4, the battery terminal 50 includes a stud bolt 51, a body portion 52, and a fastening portion 60. The stud bolt 51 is formed of a conductive metal or the like.

The body portion 52 includes a post fastening portion 53 and a bolt holding portion 54. The post fastening portion 53 is a portion to be fastened to the battery post 3. The bolt holding portion 54 is a portion that holds the stud bolt 51 connected adjacent to the post fastening portion 53. In the body portion 52, for example, a pair of annular portions 52a and 52b constituting the post fastening portion 53, a pair of plate-shaped holding portions 52c and 52d constituting the bolt holding portion 54, and a bent coupling portion 52e are integrally formed by press-bending a conductive metal plate and the like.

The pair of annular portions 52a and 52b is formed in a substantially rectangular annular shape. The pair of annular portions 52a and 52b are formed with substantially circular post insertion holes 52f and 52g into which the battery post 3 is inserted, respectively. The pair of annular portions 52a and 52b are each formed with a slit 52h which is a gap continuous with the post insertion hole 52f or 52g.

The pair of plate-shaped holding portions 52c and 52d are formed in a substantially rectangular shape, and a bolt insertion hole 52j is formed on the plate-shaped holding portion 52c.

The annular portion 52a and the annular portion 52b are integrally formed such that end portions opposite to end portions where the plate-shaped holding portions 52c and 52d are provided are continuous with each other via the bent coupling portion 52e. Accordingly, the body portion 52 is formed in a state of being folded back in a U shape with the bent coupling portion 52e interposed therebetween, and is formed in a state in which the annular portion 52a and the plate-shaped holding portion 52c, as well as the annular portion 52b and the plate-shaped holding portion 52d face each other in an upper-lower direction and are laminated in a plate shape substantially parallel to each other vertically.

The slit 52h is formed in each of the pair of annular portions 52a and 52b so as to extend from the post insertion holes 52f and 52g to the bent coupling portion 52e with a part of the annular portion 52a or 52b being divided. In the pair of annular portions 52a and 52b, a portion between the respective post insertion holes 52f and 52g and the bent coupling portion 52e forms a fastening end portion 52k which is fastened by the fastening portion 60 to be described later.

Substantially rectangular cutout portions 52l and 52m into which a part of the fastening portion 60 is fitted are formed at end portions on both sides in a width direction of the fastening end portion 52k along a longitudinal direction.

The pair of plate-shaped holding portions 52c and 52d are bent in a state where a shaft portion 51a of the stud bolt 51 is inserted into the bolt insertion hole 52j in advance before the bending process, so that the stud bolt 51 can be held in a state where the pair of plate-shaped holding portions 52c and 52d are vertically stacked via the bent coupling portion 52e. The stud bolt 51 is electrically connected to the shaft portion 51a protruding upward from the bolt insertion hole 52j by fastening, with a nut 74, the fuse circuit body 71 of the fuse unit 70, which will be described later.

The fastening portion 60 fastens the body portion 52 to the battery post 3 in a state where the battery post 3 is inserted into the post insertion holes 52f and 52g. The fastening portion 60 is in contact with the pair of annular portions 52a and 52b of the body portion 52 from both sides in a lateral direction of the body portion 52, and fastens the fastening end portions 52k of the annular portions 52a and 52b. Thus, the fastening portion 60 fastens the body portion 52 to the battery post 3.

As shown in FIG. 4, the fastening portion 60 includes a plate nut 61 as a penetrating member, a fastening bolt 62 as a screwing member, and a bracket 63 as a pressing force converting member.

The fastening portion 60 of the present embodiment is of a type in which, when the battery terminal 50 is fastened to the battery post 3, the fastening bolt 62 is fastened along the upper-lower direction along a central axis of the battery post 3. In this case, the fastening portion 60 converts a fastening force generated by the fastening bolt 62 in the upper-lower direction along a central axis X parallel to the central axis of the battery post 3 into a pressing force in a direction in which an interval between the slits 52h in the fastening end portion 52k is reduced. The fastening portion 60 fastens the body portion 52 to the battery post 3 by pressing a portion of the battery terminal 50 into which the battery post 3 is inserted by the pressing force.

The plate nut 61 includes a plate-shaped portion 61a, a contact portion 61b, a screw hole 61c, a tapered end portion 61d, and first tapered surfaces 61e, and these are integrally formed of a conductive metal or the like.

The plate-shaped portion 61a is a body portion of the plate nut 61 formed in a substantially rectangular shape, extends from one end side of the annular portions 52a and 52b to the other end side of the annular portions 52a and 52b across the slit 52h along the width direction along the longitudinal direction of the body portion 52, and is disposed in the annular portions 52a and 52b.

The contact portion 61b is provided on one end side of the plate-shaped portion 61a, and is fitted with the cutout portion 52l of the fastening end portion 52k so as to be positioned.

The screw hole 61c is formed through an end portion on the other end side of the plate-shaped portion 61a in the upper-lower direction, and the fastening bolt 62 is screwed into the screw hole 61c.

The tapered end portion 61d is formed so as to protrude to both sides in the width direction at the end portion on the other end side of the plate-shaped portion 61a, and the first tapered surfaces 61e are formed in the protruding portions respectively. The tapered end portion 61d is positioned in the plate-shaped portion 61a on the side of the cutout portion 52m of the body portion 52 in a state where the plate-shaped portion 61a is assembled so as to penetrate from the one end side of the annular portions 52a and 52b to the other end side of the annular portions 52a and 52b across the slit 52h along the width direction along the longitudinal direction of the body portion 52.

The first tapered surfaces 61e are surfaces facing and to come into contact with a second tapered surface 63e formed on the bracket 63, which will be described later.

The fastening bolt 62 is a screwing member that is screwed into the screw hole 61c formed in the plate nut 61 and moves along the central axis X with rotation around the central axis X. The fastening bolt 62 has a shaft portion 62a and a bolt head portion 62b, and these are integrally formed of a conductive metal or the like.

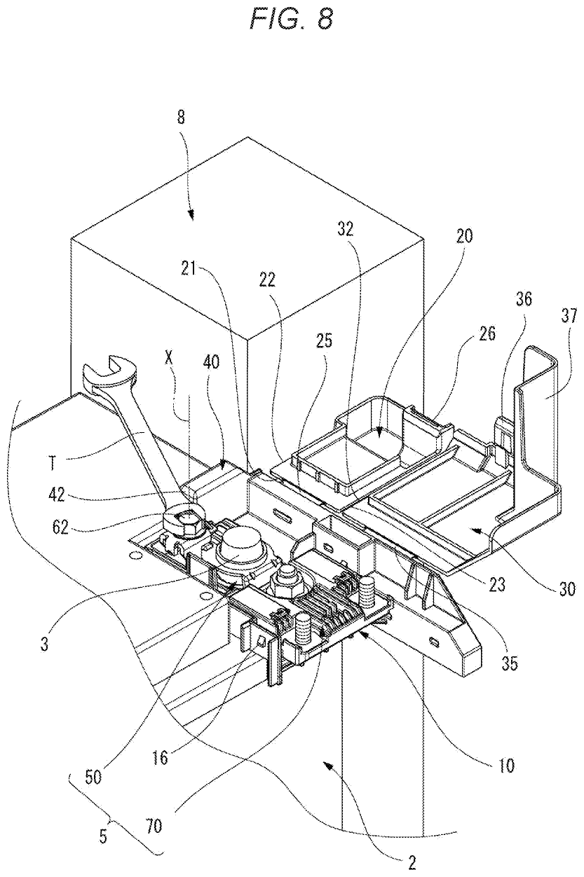

The bolt head portion 62b is formed in a hexagonal shape, and constitutes a portion to which a fastening torque is applied by a spanner T (see FIG. 8) or the like which is a tool for rotating the fastening bolt 62 around the shaft portion 62a. The fastening bolt 62 relatively moves along the central axis X with respect to the plate nut 61 due to screwing action by rotating around the central axis X in a state in which the fastening bolt 62 is screwed into the screw hole 61c.

The bracket 63 is a member that is movable along the central axis X in accordance with the movement of the fastening bolt 62 along the central axis X, and that is relatively movable along the longitudinal direction of the plate-shaped portion 61a while being in contact with the first tapered surfaces 61e of the plate nut 61. The bracket 63 is a member that converts the fastening force generated by the fastening bolt 62 in the upper-lower direction along the central axis X into the pressing force in the direction in which the interval between the slits 52h in the fastening end portion 52k is reduced.

The bracket 63 is made of a conductive metal or the like, has a base portion 63a formed in a substantially rectangular plate shape, and a pair of upright portions 63b provided on two facing sides of the base portion 63a, and is integrally formed in a substantially U shape as a whole.

A through portion 63c through which the shaft portion 62a of the fastening bolt 62 is inserted along the central axis X is formed in the base portion 63a. The through portion 63c is formed in a substantially oval shape extending along the width direction along the longitudinal direction of the body portion 52.

The pair of upright portions 63b each have a contact surface 63d to come into contact with the cutout portion 52m of the body portion 52, and the second tapered surface 63e to come into contact with the first tapered surface 61e of the plate nut 61.

The contact surface 63d is formed on a surface of the upright portion 63b on a fastening end portion 52k side in a state where the bracket 63 is assembled to the plate nut 61 via the fastening bolt 62. Each of the contact surfaces 63d is formed as a surface parallel to the central axis X of the fastening bolt 62 on an end surface of each of the upright portions 63b.

The second tapered surface 63e is formed on a surface of the upright portion 63b opposite to the contact surface 63d on a side to come into contact with the body portion 52.

That is, in a state where the bracket 63 is assembled to the plate nut 61 via the fastening bolt 62, each upright portion 63b on which the second tapered surface 63e is formed is positioned between the fastening end portion 52k and the tapered end portion 61d. The second tapered surfaces 63e of the bracket 63 face and come into contact the first tapered surfaces 61e on the tapered end portion 61d side. Each of the second tapered surfaces 63e is formed as an inclined surface in which a width is gradually narrowed from a base end side (base portion 63a side) toward a tip end side in each of the upright portions 63b in which each of the contact surfaces 63d is formed parallel to the central axis X of the fastening bolt 62.

In the fastening portion 60 configured as described above, the plate nut 61 is assembled to the body portion 52, the bracket 63 is mounted on the shaft portion 62a of the fastening bolt 62, and the shaft portion 62a is screwed into the screw hole 61c of the plate nut 61, so that the portions are assembled to each other. In the battery terminal 50, the bracket 63 and the fastening bolt 62 are assembled to the plate nut 61 in such a positional relationship that the bracket 63 is interposed between the bolt head portion 62b of the fastening bolt 62 and the plate nut 61 with respect to the central axis X of the fastening bolt 62.

Then, in the battery terminal 50, the fastening bolt 62 is fastened from an upper side in a state where inner peripheral surfaces of the post insertion holes 52f and 52g are in contact with an outer peripheral surface of the battery post 3. Accordingly, the battery terminal 50 is pressed by the pressing force that is converted and generated by each of the first tapered surfaces 61e and each of the second tapered surfaces 63e in accordance with the rotation of the fastening bolt 62 so that the interval between the slits 52h is narrowed. As a result, the battery terminal 50 is fastened to the battery post 3 with diameters of the post insertion holes 52f and 52g of the battery terminal 50 being reduced.

As shown in FIG. 3, the fuse unit 70 includes a fuse circuit body 71 and a support member 72 that supports the fuse circuit body 71.

The support member 72 is formed of an insulating material such as a synthetic resin, and the fuse circuit body 71 is insert-molded.

The fuse circuit body 71 has a fuse element (not shown) on a conduction path between the battery terminal 50 side and the electric wire 7 side. The fuse circuit body 71 is fastened together with the battery terminal 50 by screwing the stud bolt 51 and the nut 74, and is physically and electrically connected to the battery terminal 50.

Therefore, the fuse circuit body 71 is formed with a through hole 71a through which the stud bolt 51 is inserted. Further, the fuse circuit body 71 is provided with two male screw members 75 electrically connected to each other. Therefore, the fuse circuit body 71 is fastened together with a connection terminal (not shown) connected to an end of the electric wire 7 by screwing the male screw members 75 and a nut (not shown), and is electrically connected to the electric wire 7.

The power connection system 5 including the battery terminal 50 and the fuse unit 70 is accommodated in the battery terminal cover 1 formed of an insulating material such as a synthetic resin.

As shown in FIGS. 1 and 2, the battery terminal cover 1 according to the first embodiment includes a base portion 10 fixed to the battery 2, a first cover 20 coupled to the base portion 10 via a first hinge 25, and a second cover 30 coupled to the base portion 10 via a second hinge 35.

As shown in FIGS. 3, 5, and 6, the base portion 10 has a circular through hole 14 through which the battery post 3 is inserted, and is installed on the upper face of the battery 2 such that the battery post 3 is inserted through the through hole 14.

A terminal accommodating chamber 11 for accommodating the battery terminal 50 is formed in the installed base portion 10. A free end side of the battery post 3 inserted into the through hole 14 is disposed in the terminal accommodating chamber 11. In the terminal accommodating chamber 11, the battery terminal 50 is placed on the base portion 10 while the battery post 3 is inserted from the free end side, and is maintained in an accommodated state by a locking structure such as a locking protrusion 17. The battery terminal 50 is physically and electrically connected to the free end side of the battery post 3 by the fastening portion 60.

Further, the base portion 10 is provided with a unit accommodating chamber 15 for accommodating the fuse unit 70. The fuse unit 70 is attached to the battery terminal 50 accommodated in the terminal accommodating chamber 11. Therefore, the stud bolt 51 of the battery terminal 50 accommodated in the terminal accommodating chamber 11 is disposed in the unit accommodating chamber 15. In the unit accommodating chamber 15, the stud bolt 51 is inserted into the through hole 71a of the fuse circuit body 71 of the fuse unit 70, the fuse circuit body 71 of the fuse unit 70 is placed on the battery terminal 50, and the support member 72 of the fuse unit 70 is placed on the base portion 10.

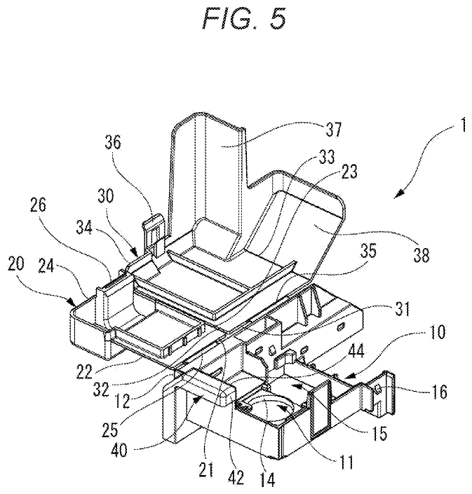

As shown in FIG. 5, the first cover 20 is coupled to one side wall 12 of the base portion 10 via the first hinge 25, and can cover an upper opening of the terminal accommodating chamber 11 in an openable and closable manner. That is, the first cover 20 can be rotationally displaced to a shielding position at which the first cover 20 covers the fastening bolt 62, which is the screwing member attached to the battery terminal 50, and to an exposed position at which the fastening bolt 62 is exposed.

The first cover 20 is formed in a substantially rectangular plate shape having a base end side edge portion 21 coupled to the first hinge 25, a pair of width direction side edge portions 22 and 23 extending in parallel to each other from both ends of the base end side edge portion 21, and a rotation tip end portion 24 which is an opposing side of the base end side edge portion 21.

A lock arm 26 is provided at the rotation tip end portion 24 of the first cover 20. The first cover 20 is held at the shielding position by the lock arm 26 being locked to a locking protrusion 13 provided at a corresponding position of the base portion 10.

The second cover 30 arranged side by side with the first cover 20 is coupled to the one side wall 12 of the base portion 10 via the second hinge 35, and can cover an upper opening of the unit accommodating chamber 15 in an openable and closable manner. That is, the second cover 30 can be rotationally displaced to a shielding position at which the second cover 30 covers the fuse unit 70 attached to the battery terminal 50, and to an exposed position at which the fuse unit 70 is exposed.

The second cover 30 is formed in a substantially rectangular plate shape having a base end side edge portion 31 coupled to the second hinge 35, a pair of width direction side edge portions 32 and 33 extending in parallel to each other from both ends of the base end side edge portion 31, and a rotation tip end portion 34 which is an opposing side of the base end side edge portion 31.

A lock piece 36 is provided at the rotation tip end portion 34 of the second cover 30. The second cover 30 is held at the shielding position by the lock piece 36 being locked to a locking protrusion 16 provided at a corresponding position of the base portion 10.

The width direction side edge portion 33 of the second cover 30 is provided with electric wire covering portions 37 and 38 that respectively regulate lead-out directions of the two electric wires 7 whose ends are connected to the fuse circuit body 71.

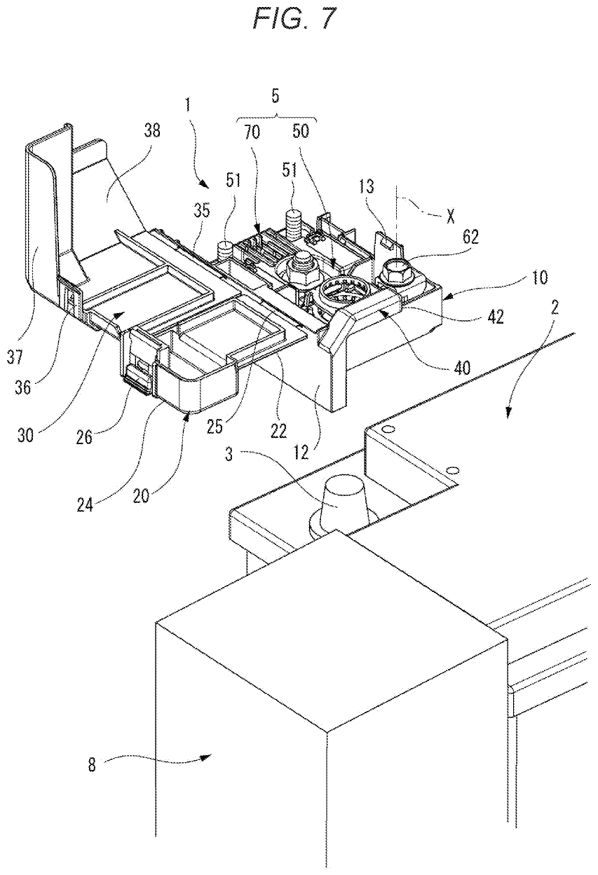

Further, the base portion 10 of the battery terminal cover 1 is provided with a first protruding rib 40 as a tool restriction portion that protrudes into a rotation trajectory until the spanner T comes into contact with a peripheral member 8 (see FIGS. 7 and 8) disposed around the battery 2 when the fastening bolt 62 of the battery terminal 50 is fastened, and restricts the rotation of the spanner T by interfering with the spanner T before coming into contact with the peripheral member 8.

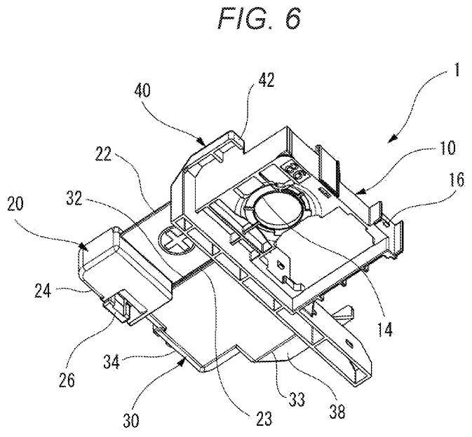

As shown in FIGS. 5 and 6, the first protruding rib 40 is a box-shaped protruding rib that protrudes to the upper side of a peripheral wall of the base portion 10 on the terminal accommodating chamber 11 side, extends from the one side wall 12 side to an opposing side wall side, and opens downward. The box-shaped first protruding rib 40 having a reinforcing rib therein has a sufficient strength to restrict the rotation of the spanner T.

A side wall of the first protruding rib 40 facing one width direction side edge portion 22 of the first cover 20 to be opened and closed is a guide surface 44 orthogonal to the width direction side edge portion 22. An extending end wall of the first protruding rib 40 serves as a rotation restricting end portion 42 to come into contact with the spanner T.

As shown in FIG. 7, the peripheral member 8, which is a contact inhibition component, is disposed in the vicinity of a side of the battery 2 to which the power connection system 5 accommodated in the battery terminal cover 1 is assembled, or a part of a vehicle body is close to the battery 2.

Here, as shown in FIG. 8, according to the battery terminal cover 1 of the first embodiment, when the fastening bolt 62 of the battery terminal 50 is rotated using the spanner T, the spanner T rotated in a horizontal direction about the central axis X of the fastening bolt 62 extending in the upper-lower direction of the base portion 10 comes into contact with the rotation restricting end portion 42 of the first protruding rib 40, and further rotation is restricted.

Therefore, the spanner T does not come into contact with the peripheral member 8 disposed on the side of the battery 2, and it is possible to prevent the peripheral member 8 from being damaged. In addition, when the peripheral member 8 is a conductive member in which a short circuit occurs between the peripheral member 8 and a positive electrode battery post 3, it is possible to prevent the occurrence of the short circuit.

Further, the first protruding rib 40 is provided on the base portion 10 fixed to the battery 2. Therefore, even when the rotated spanner T interferes (comes into contact) with the first protruding rib 40, a rotational force of the spanner T is not applied to the first hinge 25 of the first cover 20 and the second hinge 35 of the second cover 30, and the first hinge 25 and the second hinge 35 are prevented from being damaged.

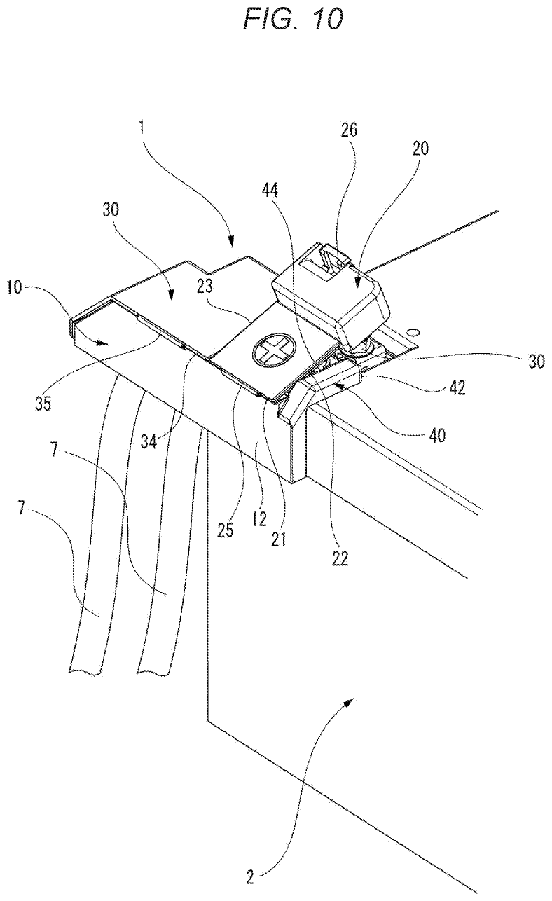

In addition, the side wall of the first protruding rib 40 facing the one width direction side edge portion 22 of the first cover 20 to be opened and closed is the guide surface 44 orthogonal to the width direction side edge portion 22. Therefore, as shown in FIG. 10, when the first cover 20 is opened and closed, the guide surface 44 of the first protruding rib 40 provided on the base portion 10 can restrict swing of the first cover 20 in the width direction and prevent torsion of the first hinge 25. Therefore, it is possible to prevent the first hinge 25 from being damaged due to the repetition of the opening and closing of the first cover 20.

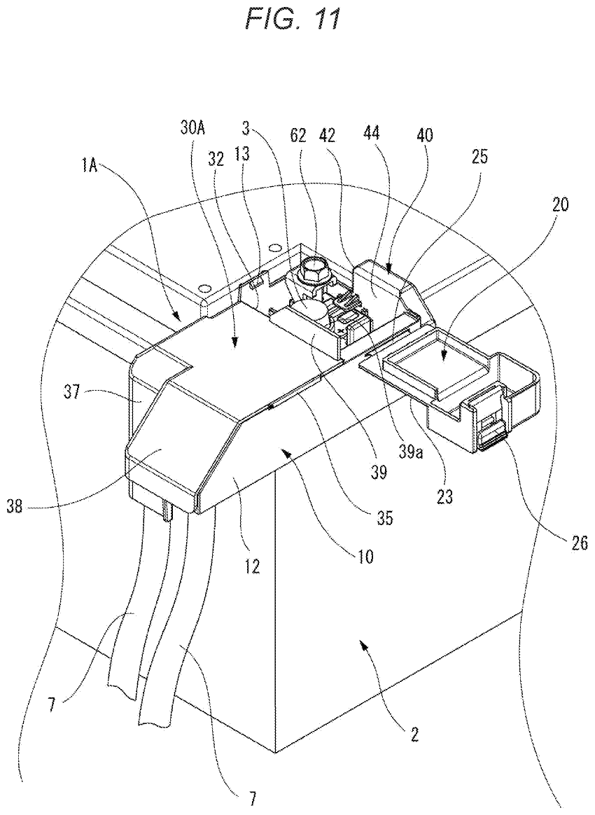

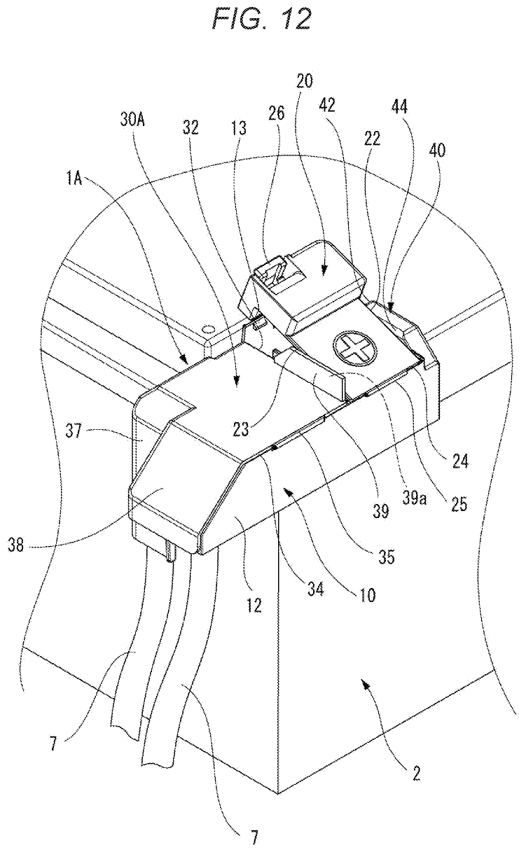

Next, a battery terminal cover 1A as a cover member according to a second embodiment of the present invention assembled to the battery 2 will be described with reference to FIGS. 11 and 12. In the battery terminal cover 1A according to the second embodiment, the same components as those of the battery terminal cover 1 according to the first embodiment are denoted by the same reference numerals, and a detailed description thereof will be omitted.

As shown in FIG. 11, in the battery terminal cover 1A according to the second embodiment, a plate-shaped second protruding rib 39 protruding to the upper side of the base portion 10 is provided on the width direction side edge portion 32 of a second cover 30A adjacent to the other width direction side edge portion 23 of the first cover 20. The second protruding rib 39 has a guide surface 39a that faces the other width direction side edge portion 23 of the first cover 20 to be opened and closed and that is parallel to the guide surface 44 of the first protruding rib 40.

Therefore, according to the battery terminal cover 1A of the second embodiment, as shown in FIG. 12, when the first cover 20 is opened and closed, the guide surface of the second protruding rib 39 provided on the width direction side edge portion 32 of the second cover 30A restricts the swing of the first cover 20 in the width direction between the guide surface of the second protruding rib 39 and the guide surface 44 of the first protruding rib 40 from both sides, and it is possible to reliably prevent the torsion of the first hinge 25. Therefore, it is possible to further prevent the first hinge 25 from being damaged due to the repetition of the opening and closing of the first cover 20.

Therefore, according to the battery terminal cover 1 or 1A of the first or second embodiment, the rotation of the spanner T can be restricted, and the first hinge 25 and the second hinge 35 can be prevented from being damaged.

It should be noted that the present disclosure is not limited to the above embodiment, and modifications, improvements, and the like can be made as appropriate. In addition, materials, shapes, dimensions, numbers, arrangement positions, and the like of the respective constituent elements in the above embodiment are optionally selected and are not limited as long as the present disclosure can be implemented.

The connection terminal (not shown) connected to the end of the electric wire 7 is electrically and indirectly connected to the battery terminal 50 of the above embodiment via the fuse circuit body 71 of the fuse unit 70, but the present invention is not limited thereto. The connection terminal connected to the end of the electric wire 7 may be physically and electrically connected to the battery terminal 50 directly.

Here, features of the cover member according to the embodiment of the present disclosure described above will be briefly summarized and listed in [1] to [4] below. [1] A cover member (battery terminal cover 1, 1A) including:
a base portion (10) that is fixed to a battery (2) and accommodates a battery terminal (50);
a first cover (20) that is coupled to the base portion (10) via a first hinge (25) and is configured to be rotationally displaceable between a first shielding position at which the first cover (20) covers a screwing member (fastening bolt 62) attached to the battery terminal (50) and a first exposed position at which the screwing member (fastening bolt 62) is exposed; and
a tool restriction portion (first protruding rib 40) that is provided in the base portion (10) and restricts rotation of a tool (spanner T) rotated about the screwing member (fastening bolt 62) by interfering with the tool (spanner T) before the tool (spanner T) comes into contact with a peripheral member (8) disposed around the battery (2).

According to the cover member (battery terminal cover 1, 1A) having the configuration of [1], when the screwing member (fastening bolt 62) of the battery terminal (50) is rotated using the tool (spanner T), the tool (spanner T) rotated about the screwing member (fastening bolt 62) comes into contact with the tool restriction portion (first protruding rib 40), and further rotation is restricted.

Therefore, the tool (spanner T) does not come into contact with the peripheral member (8) disposed around the battery (2), and it is possible to prevent the peripheral member (8) from being damaged.

Further, the tool restriction portion (first protruding rib 40) is provided on the base portion (10) fixed to the battery (2). Therefore, even when the rotated tool (spanner T) interferes with (comes into contact with) the tool restriction portion (first protruding rib 40), a rotational force of the tool (spanner T) is not applied to the first hinge (25) of the first cover (20), and the damage is prevented.

[2] In the cover member (battery terminal cover 1, 1A) according to [1],
a central axis (X) of the screwing member (fastening bolt 62) constituting a fastening portion (60) for fastening the battery terminal (50) to a battery post (3) of the battery (2) extends in an upper-lower direction of the base portion (10) in parallel with a central axis of the battery post (3).

According to the cover member (battery terminal cover 1, 1A) having the configuration of [2], when the screwing member (fastening bolt 62) of the battery terminal (50) is rotated using the tool (spanner T), the tool (spanner T) rotated in a horizontal direction about the central axis (X) of the screwing member (fastening bolt 62) extending in the upper-lower direction of the base portion (10) comes into contact with the tool restriction portion (first protruding rib 40), and further rotation is restricted.

Therefore, the tool (spanner T) does not come into contact with the peripheral member (8) disposed on a side of the battery (2).

[3] In the cover member (battery terminal cover 1, 1A) according to [1] or [2],
the first cover (20) includes a base end side edge portion (21) coupled to the first hinge (25) and a pair of first width direction side edge portions (22, 23) extending in parallel with each other from both ends of the base end side edge portion (21), and
the tool restriction portion is a first protruding rib (40) having a guide surface (44) facing one of the first width direction side edge portions (22) and protruding upward from the base portion (10).

According to the cover member (battery terminal cover 1, 1A) having the configuration of [3], when the first cover (20) is opened and closed, the guide surface (44) of the first protruding rib (40) provided on the base portion (10) can restrict swing of the first cover (20) in the width direction and prevent torsion of the first hinge (25). Therefore, it is possible to prevent the first hinge (25) from being damaged due to the repetition of the opening and closing of the first cover (20).

[4] The cover member (battery terminal cover 1A) according to [3], further including:
a second cover (30A) that is coupled to the base portion (10) via a second hinge (35) and is configured to be rotationally displaceable between a second shielding position at which the second cover (30A) covers a fuse unit (70) attached to the battery terminal (50) and a second exposed position at which the fuse unit (70) is exposed; and
a second protruding rib (39) that is provided on a second width direction side edge portion (32) of the second cover (30A) adjacent to the other first width direction side edge portion (23) of the first cover (20), has a guide surface (39a) facing the other first width direction side edge portion (23) of the first cover (20), and protrudes upward from the base portion (10).

According to the cover member (battery terminal cover 1A) having the configuration of [4], when the first cover (20) is opened and closed, the guide surface (39a) of the second protruding rib (39) provided on the width direction side edge portion (32) of the second cover (30A) restricts the swing of the first cover (20) in the width direction between the guide surface (39a) of the second protruding rib (39) and the guide surface (44) of the first protruding rib (40) from both sides, and it is possible to reliably prevent the torsion of the first hinge (25). Therefore, it is possible to further prevent the first hinge (25) from being damaged due to the repetition of the opening and closing of the first cover (20).

What is claimed is:

1. A cover member comprising:
a base portion that is fixed to a battery and accommodates a battery terminal;
a first cover that is coupled to the base portion via a first hinge and is configured to be rotationally displaceable between a first shielding position at which the first cover covers a screwing member attached to the battery terminal and a first exposed position at which the screwing member is exposed; and
a tool restriction portion that is provided in the base portion and restricts rotation of a tool rotated about the screwing member by interfering with the tool before the tool comes into contact with a peripheral member disposed around the battery.

2. The cover member according to claim 1, further comprising
the screwing member that has a fastening portion for fastening the battery terminal to a battery post of the battery,
wherein a central axis of the screwing member extends in an upper-lower direction of the base portion in parallel with a central axis of the battery post.

3. The cover member according to claim 1,
wherein the first cover includes a base end side edge portion coupled to the first hinge and a pair of first width direction side edge portions extending in parallel with each other from both ends of the base end side edge portion, and
wherein the tool restriction portion is a first protruding rib having a guide surface facing one of the first width direction side edge portions and protruding upward from the base portion.

4. The cover member according to claim 3, further comprising:
a second cover that is coupled to the base portion via a second hinge and is configured to be rotationally displaceable between a second shielding position at which the second cover covers a fuse unit attached to the battery terminal and a second exposed position at which the fuse unit is exposed; and
a second protruding rib that is provided on a second width direction side edge portion of the second cover adjacent to the other first width direction side edge portion of the first cover, has a guide surface facing the other first width direction side edge portion of the first cover, and protrudes upward from the base portion.
